(19) United States
(12) Patent Application Publication
(10) Pub. No.: US 2024/0208123 A1
(43) Pub. Date: Jun. 27, 2024

(54) MOLDS AND APPARATUS FOR MOLDING OPTICAL COMPONENTS

(71) Applicant: Meta Platforms Technologies, LLC, Menlo Park, CA (US)

(72) Inventors: Christopher Jack BROWN, Deming, WA (US); Kurt JENKINS, Sammamish, WA (US)

(21) Appl. No.: 17/848,234

(22) Filed: Jun. 23, 2022

Related U.S. Application Data
(60) Provisional application No. 63/215,904, filed on Jun. 28, 2021.

(51) Int. Cl. B29C 45/64; B29C 45/26; B29C 45/73

(52) U.S. Cl. CPC B29C 45/64; B29C 45/26; B29C 45/73; B29L 2011/0016

(57) ABSTRACT

A mold assembly includes a first mold, a second mold, and a lock mounted on one of the first mold or the second mold and releasably coupled with the other of the first mold or the second mold for maintaining a position of the other of the first mold or the second mold relative to the one of the first mold or the second mold while the lock is in a closed position. Also disclosed are a molding apparatus and a method for molding.

### RELATED APPLICATIONS

This application claims the benefit of, and priority to, U.S. Provisional Patent Application Ser. No. 63/215,904, filed Jun. 28, 2021, which is incorporated by reference herein in its entirety.

### TECHNICAL FIELD

This relates generally to molding of optical components, and more specifically to devices and apparatus for molding optical components.

### BACKGROUND

Optical components (e.g., lenses) are used in various applications, such as displays, imaging (e.g., with cameras), various sensing and measurements, etc. In addition, head-mounted display devices (also called herein head-mounted displays) are gaining popularity as a means for providing visual information to users. With the technical advances in such applications, the demand for optical components has also increased.

### SUMMARY

Accordingly, there is a need for rapid manufacturing of optical components that can be easily incorporated into optical devices. The methods and devices disclosed herein allow increased throughput in lenses manufacturing.

In accordance with some embodiments, a mold assembly includes a first mold, a second mold, and a lock mounted on one of the first mold or the second mold and releasably coupled with the other of the first mold or the second mold for maintaining a position of the other of the first mold or the second mold relative to the one of the first mold or the second mold while the lock is in a closed position.

In accordance with some embodiments, an apparatus for molding includes a first platen; a second platen; and one or more actuators coupled with at least one of the first platen or the second platen for: changing a distance between the first platen and the second platen; and changing a position of a mold assembly on the second platen relative to the first platen.

In accordance with some embodiments, a method includes maintaining a first platen of any apparatus described herein in contact with a second mold of the mold assembly located at a first position while molten material is in the mold assembly; releasing the first platen from the second mold of the mold assembly; and, subsequent to releasing the first platen from the second mold of the mold assembly, moving the mold assembly from the first position to a second position distinct from the first position.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 illustrates a mold assembly in accordance with some embodiments.

FIGS. 2A-2I illustrate operations in making of an optical component by molding in accordance with some embodiments.

FIG. 3A is a schematic diagram illustrating a plan view of an apparatus for molding in accordance with some embodiments.

FIG. 3B is a schematic diagram illustrating a plan view of an apparatus for molding in accordance with some other embodiments.

FIG. 3C is a schematic diagram illustrating a side view of an apparatus with a rotary bottom platen in accordance with some embodiments.

FIG. 3D is a schematic diagram illustrating a side view of an apparatus with a linear stage in accordance with some embodiments.

FIG. 4 is a block diagram illustrating a method of making an optical component by molding in accordance with some embodiments.

FIG. 5 is a perspective view of a display device in accordance with some embodiments.

FIG. 6 is a block diagram of a system including a display device in accordance with some embodiments.

FIG. 7 is an isometric view of a display device in accordance with some embodiments.

These figures are not drawn to scale unless indicated otherwise.

### DETAILED DESCRIPTION

Molding is often used to make optical components. For example, optical components (e.g., lenses, prisms, etc.) may be made by molding from thermoplastic material (e.g., acrylic, styrene, polycarbonate, cyclic-olefin polymers, cyclic-olefin copolymers). In some cases, injection molding or compression molding is used. In some cases, insertion molding (also called insert molding) is used to make optical components having complex shapes (e.g., an assembly of multiple optical components) in a single molding process.

Molding typically includes multiple distinct operations, such as mold closing, injection of molding material, packing and holding (also called dwelling), cooling (and plasticizing), mold opening, and part ejection. Typically cooling takes a substantial portion of a molding cycle. If a molded part occupies a platen during the cooling operation, the throughput of the molding process is limited by the cooling time. As described herein, placing the molded part away from a platen during the cooling cycle frees the platen during the cooling of the molded part, which allows the platen to be used for molding of subsequent parts. This, in turn, increases the throughput of a molding process.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first platen could be termed a second platen, and, similarly, a second platen could be termed a first platen, without departing from the scope of the various described embodiments. The first platen and the second platen are both platens, but they are not the same platen.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “exemplary” is used herein in the sense of “serving as an example, instance, or illustration” and not in the sense of “representing the best of its kind.”

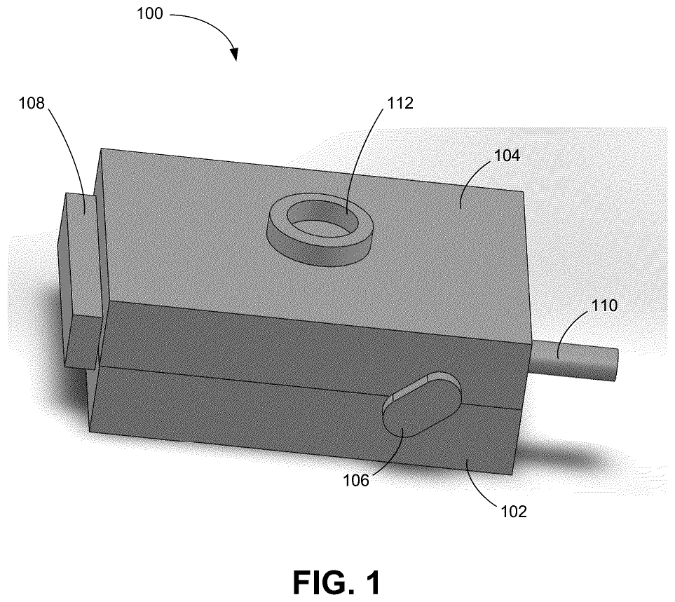

FIG. 1 illustrates a mold assembly 100 in accordance with some embodiments.

The mold assembly 100 includes a first mold 102 (e.g., a bottom mold) and a second mold 104 (e.g., a top mold).

In some embodiments, the mold assembly 100 also includes a lock 106 for maintaining positions of the first mold 102 and the second mold 104 relative to each other while the lock is in a closed position (e.g., when the lock 106 is engaged, the lock 106 maintains the mold assembly in a closed position). This allows maintaining the pressure within a cavity between the first mold 102 and the second mold 104 even when at least one of the first mold 102 or the second mold 104 is not in contact with a platen (e.g., no external pressure is applied by a platen on the first mold 102 and the second mold 104) so that the molding operations may continue even when the mold assembly 100 is moved away from at least one platen. In some embodiments, the lock 106 is rotatably mounted on the first mold 102 for releasably coupling with the second mold 104. In some embodiments, the lock 106 is rotatably mounted on the second mold 104 for releasably coupling with the first mold 102. While the lock 106 is in an open position (e.g., a lock rotatably mounted on the first mold 102 is not engaging the second mold 104), the second mold 104 is movable relative to the first mold 102 (e.g., the second mold 104 may be tilted away from the first mold 102).

Although FIG. 1 shows one lock 106, in some embodiments, the mold assembly 100 includes two or more locks (e.g., two, three, four, five, six, seven, eight, etc.).

In some embodiments, the lock 106 includes a latch. In some embodiments, the lock 106 includes a swivel for rotating the latch. In some embodiment, the latch is configured to engage with a pin, a hook, a keeper, or a strike on the other mold.

In some embodiments, the first mold 102 is rotatably coupled with the second mold 104 (e.g., the first mold 102 and the second mold 104 are connected by a hinge 108). In some embodiments, the first mold 102 and the second mold 104 are connected by two or more hinges.

In some embodiments, the second mold 104 is coupled with a handle 110. The handle 110 is used for lifting the second mold 104 at least partially away from the first mold 102 (e.g., the handle 110 is used to separate the second mold 104 and the first mold 102 along a parting line).

In some embodiments, at least one of the first mold 102 or the second mold 104 includes one or more markers 112 indicating a position of the mold assembly. In some embodiments, the one or more markers 112 are used for positioning or aligning the mold assembly on a platen. In some embodiments, the one or more markers 112 include a marker having a shape of a ring (e.g., a locator ring). In some embodiments, the one or more markers 112 may have any other shapes (e.g., indentations, protrusions, shapes of dots, lines, squares, rectangles, circles, ellipsoids, triangles, wedges, trapezoids, parallelograms, and other polygons, such as pentagons, hexagons, etc.). In some embodiments, the one or more markers 112 include a marker positioned at a center of a top surface of a mold (e.g., the second mold 104).

In some embodiments, the mold assembly 100 includes one or more holes or slots for injecting molding material into the mold assembly 100 (e.g., into one or more cavities formed between the first mold 102 and the second mold 104). In some embodiments, only one cavity is defined between the first mold 102 and the second mold 104. In some embodiments, two or more cavities (e.g., 2, 3, 4, 5, 6, 7, 8, 9, 10 or more cavities) are defined between the first mold 102 and the second mold 104. In some embodiments, the one or more holes or slots include a hole or a slot located adjacent to (e.g., along) a parting line between the first mold 102 and the second mold 104. In some embodiments, the one or more holes or slots include a through-hole or a slot located on the first mold 102 or the second mold 104.

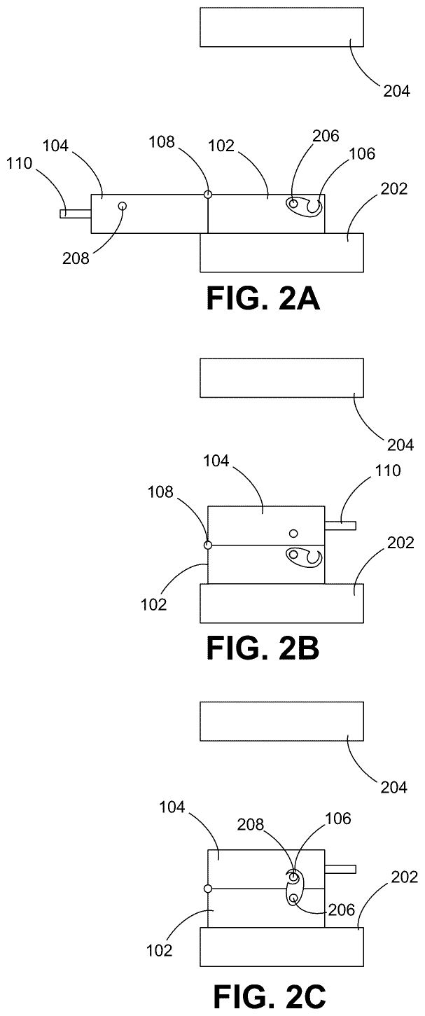

FIGS. 2A-2I illustrate operations in making of an optical component by molding in accordance with some embodiments.

In FIG. 2A, a mold assembly is placed on a platen 202 (e.g., a bottom platen). The mold assembly in FIG. 2A is in an open configuration (e.g., the lock 106 rotatably mounted on the first mold 102 by a swivel mount 206 is in a position disengaged from a locking pin 208 on the second mold 104) so that the first mold 102 is not mated with the second mold 104 and the cavities on the first mold 102 and the second mold 104 are exposed.

FIG. 2B illustrates that mold assembly is in a closed configuration (e.g., the second mold 104 is in a mating position with the first mold 102). In some embodiments, the mold assembly is closed by moving the second mold 104 with the handle 110 (e.g., manually, or automatically with an actuator of a molding apparatus).

FIG. 2C illustrates that the lock 106 is engage with the second mold 104 (e.g., with the locking pin 208 on the second mold 104). In some embodiments, the lock 106 is engaged manually, or automatically with an actuator of a molding apparatus.

FIG. 2D illustrates that the platen 204 has moved down to come in contact with the second mold 104, thereby providing pressure on the first mold 102 and the second mold 104.

FIG. 2E illustrates that molding material 210 is injected into one or more cavities defined in the mold assembly while the platen 204 remains in contact with the second mold 104.

FIG. 2F illustrates that the platen 204 ceases to be in contact with the second mold 104 (e.g., the platen 204 is moved away from the second mold 104). The platen 204 may be moved away from the second mold 104 before the molding material 210 has fully cooled down (e.g., during dwelling).

FIG. 2G illustrates that the mold assembly is moved away from a position on the platen 202 and a second mold assembly (e.g., with mold 102-2 and mold 102-4) is placed on the platen 202. In some embodiments, the mold 104-2 is coupled with a handle 110-2.

FIG. 2H illustrates that while the mold assembly is cooling away from the position on the platen 202 to form a molded optical component 220, the second mold assembly is closed (e.g., using a hinge 108-2).

FIG. 2I illustrates that while the mold assembly is away from the position on the platen 202, further molding operations are performed with the second mold assembly, such as engaging the lock 106-2. FIG. 2I also illustrates that the mold assembly is opened so that the molded optical component 220 may be ejected from the mold assembly.

Although FIGS. 2A-2I illustrate molding operations in accordance with some embodiments, the molding operations may be carried in different orders. For example, moving the platen 204 down (shown in FIG. 2D) may be performed before engaging the lock 106 (shown in FIG. 2C). In another example, the mold assembly may be in a closed configuration when the mold assembly is placed on the platen 202 (instead of placing the mold assembly on the platen 202 and closing the mold assembly as shown in FIGS. 2A-2B). For brevity, all such variations are not repeated herein.

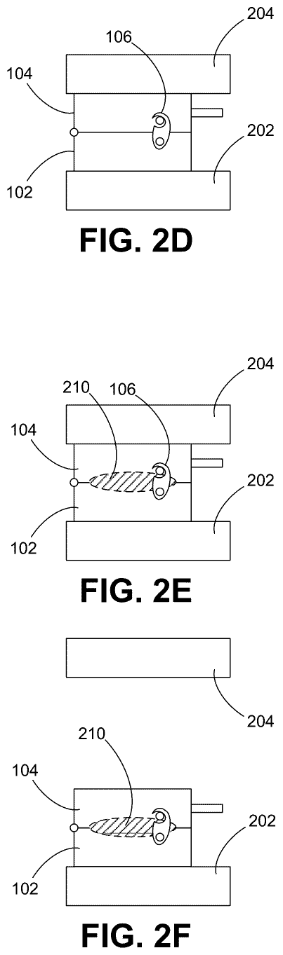

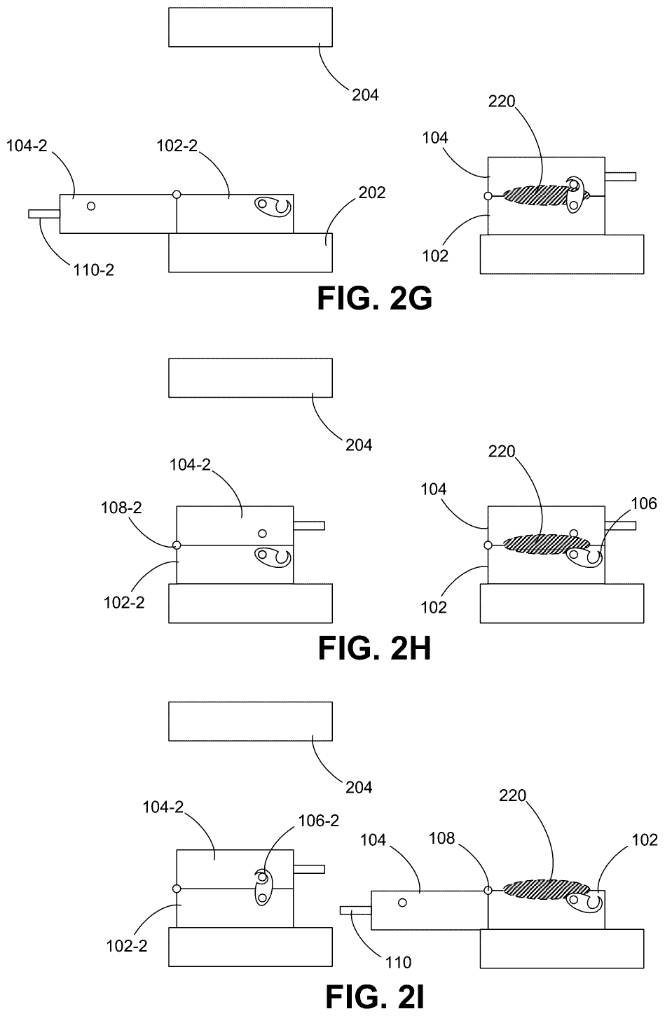

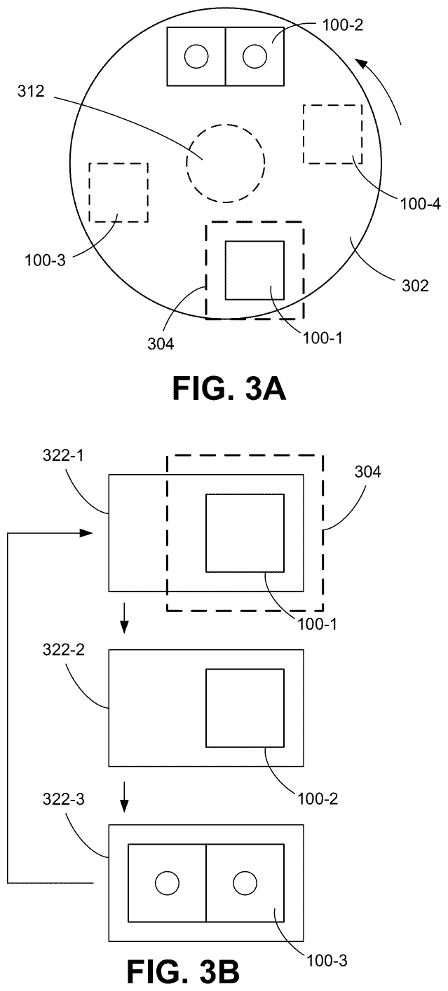

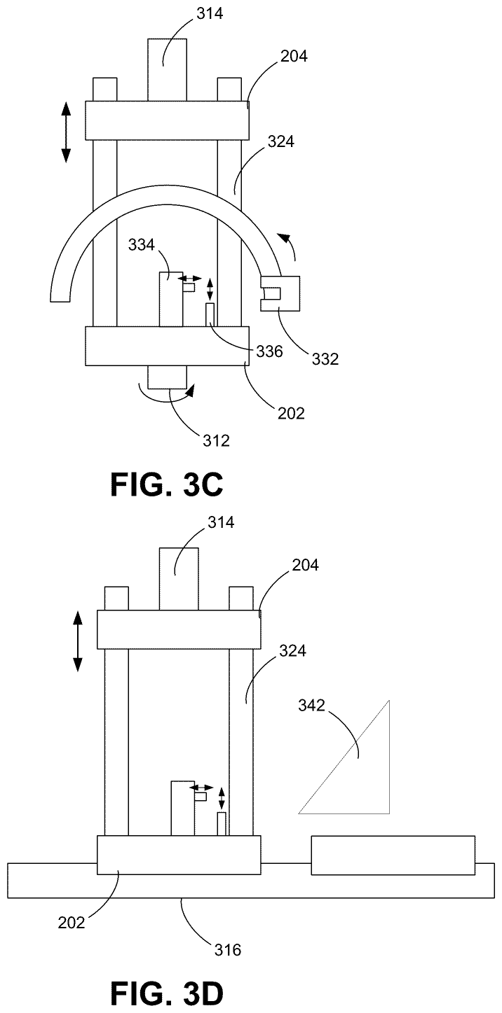

FIG. 3A is a schematic diagram illustrating a plan view of an apparatus for molding in accordance with some embodiments.

In FIG. 3A, the apparatus includes a rotary bottom platen 302. Two or more mold assemblies (e.g., mold assemblies 100-1 and 100-2) are placed on the platen 302. In some embodiments, additional mold assemblies (e.g., mold assemblies 100-3 and 100-4) may be placed on the bottom platen 302 (e.g., three, four, five, six, seven, eight, nine, ten or more molds may be placed on the bottom platen 302).

In some embodiments, a top platen 304 is located over one region of the bottom platen 302. The top platen 304 may be moved toward the bottom platen 302 to apply a pressure on a mold assembly (e.g., mold assembly 100-1) located between the bottom platen 302 and the top platen 304 (e.g., before and during injection of molding material).

The platen 302 is coupled with a rotary actuator 312 for rotating the platen 302. For example, the rotary actuator 312 rotates the platen 302 after the top platen 304 has been lifted after injection of molding material into the mold assembly 100-1 so that the mold assembly moves to a new location (where the mold assembly 100-4 is currently located) and another mold assembly (e.g., mold assembly 100-3 or 100-2) moves under the top platen 304.

FIG. 3B is a schematic diagram illustrating a plan view of an apparatus for molding in accordance with some other embodiments.

The apparatus shown in FIG. 3B is similar to the apparatus shown in FIG. 3A except that the apparatus shown in FIG. 3B includes a linear stage instead of a rotary bottom platen 302.

In some embodiments, the apparatus includes multiple bottom platens 322-1, 322-2, and 322-3, which are moved linearly. For example, after injection of molding material into the mold assembly 100-1 and lifting of the top platen 304, the platen 322-1 with the mold assembly 100-1 moves to a location where the platen 322-2 is currently located, the platen 322-2 with the mold assembly 100-2 moves to a location where the platen 322-3 is located, and the platen 322-3 with the mold assembly 100-3 moves to a location under the top platen 304.

Although FIG. 3B shows that a single mold assembly is located on a bottom platen, two or more mold assemblies may be located on a single bottom platen. Although FIG. 3B shows that there is only one part molded from a single mold assembly, in some embodiments, multiple parts are molded concurrently from a single mold assembly.

FIG. 3C is a schematic diagram illustrating a side view of an apparatus with a rotary bottom platen (e.g., the apparatus shown in FIG. 3A) in accordance with some embodiments. The apparatus shown in FIG. 3C includes an actuator 312 for rotating the bottom platen 202, and an actuator 314 for moving the top platen 204 vertically. In some embodiments, the apparatus includes an actuator for moving the bottom platen 202 vertically instead of, or in addition to, the actuator 314. In some embodiments, the apparatus includes one or more guides 324 for guiding the movement (e.g., a vertical movement) of the platen 204.

FIG. 3C also shows an actuator 332 (e.g., a rotary actuator) for engaging with the top mold (e.g., mold 104 of a mold assembly), for example by the handle 110, to open and/or close the mold assembly. Also shown in FIG. 3C are an actuator 334 for disengaging a lock of a mold assembly and an actuator 336 for engaging the lock.

FIG. 3D is a schematic diagram illustrating a side view of an apparatus with a linear stage (e.g., the apparatus shown in FIG. 3B) in accordance with some embodiments. The apparatus shown in FIG. 3D is similar to the apparatus shown in FIG. 3C, except that the apparatus shown in FIG. 3D includes a stage 316 (e.g., a linear stage) for moving a mold assembly (or a platen with a mold assembly thereon).

FIG. 3D also shows that the apparatus may include a ramp 342 for opening the mold assembly instead of the actuator 332.

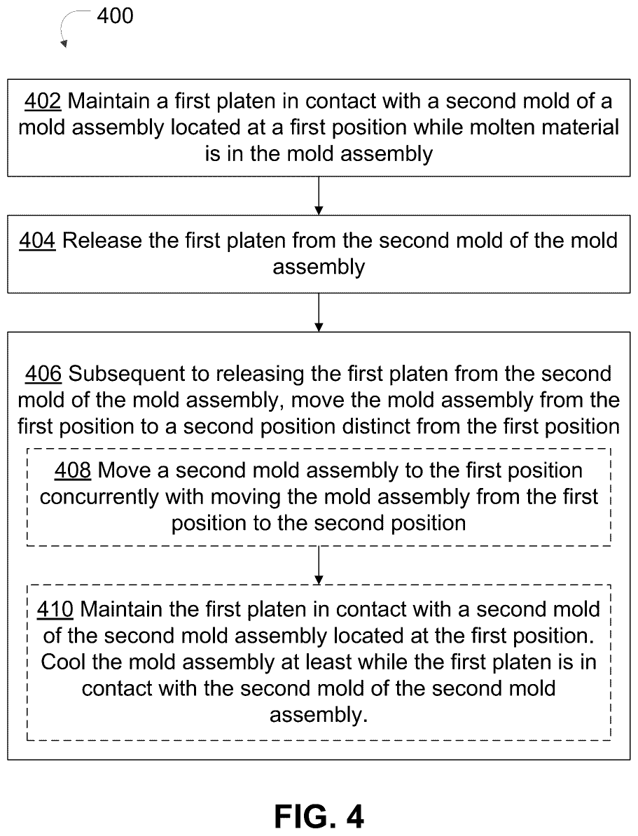

FIG. 4 is a block diagram illustrating a method 400 of making an optical component by molding in accordance with some embodiments.

The method includes (402) maintaining a first platen (e.g., a top platen of any apparatus described herein) in contact with a second mold of the mold assembly located at a first position while molten material is in the mold assembly (e.g., during the injection of molding material into the mold assembly, as shown in FIG. 2E).

In some embodiments, the method includes bringing the first platen in contact with the second mold of the mold assembly (e.g., FIG. 2D) before injecting the molding material into the mold assembly.

The method also includes (404) releasing the first platen from the second mold of the mold assembly (e.g., FIG. 2F).

The method further includes, subsequent to releasing the first platen from the second mold of the mold assembly, (406) moving the mold assembly from the first position to a second position distinct from the first position (e.g., FIG. 2G).

In some embodiments, the method includes (408) moving a second mold assembly to the first position concurrently with moving the mold assembly from the first position to the second position (e.g., as shown in FIG. 2G, the second mold assembly is moved into a position between the platen 202 and the platen 204).

In some embodiments, the method includes (410) maintaining the first platen in contact with a second mold of the second mold assembly located at the first position (e.g., FIG. 2I); and cooling the mold assembly at least while the first platen is in contact with the second mold of the second mold assembly.

The optical components made by any method described herein may be included in various optical devices.

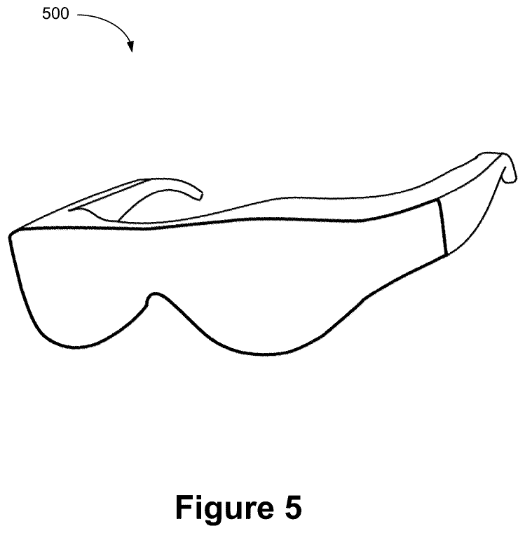

For example, FIG. 5 illustrates display device 500 in accordance with some embodiments. In some embodiments, display device 500 is configured to be worn on the head of a user (e.g., by having the form of spectacles or eyeglasses, as shown in FIG. 5) or to be included as part of a helmet that is to be worn by the user. When display device 500 is configured to be worn on a head of a user or to be included as part of a helmet or headset, display device 500 is called a head-mounted display. Alternatively, display device 500 is configured for placement in proximity of an eye or eyes of the user at a fixed location, without being head-mounted (e.g., display device 500 is mounted in a vehicle, such as a car or an airplane, for placement in front of an eye or eyes of the user). As shown in FIG. 5, display device 500 includes display 510. Display 510 is configured for presenting visual content (e.g., augmented reality content, virtual reality content, mixed reality content, or any combination thereof) to a user.

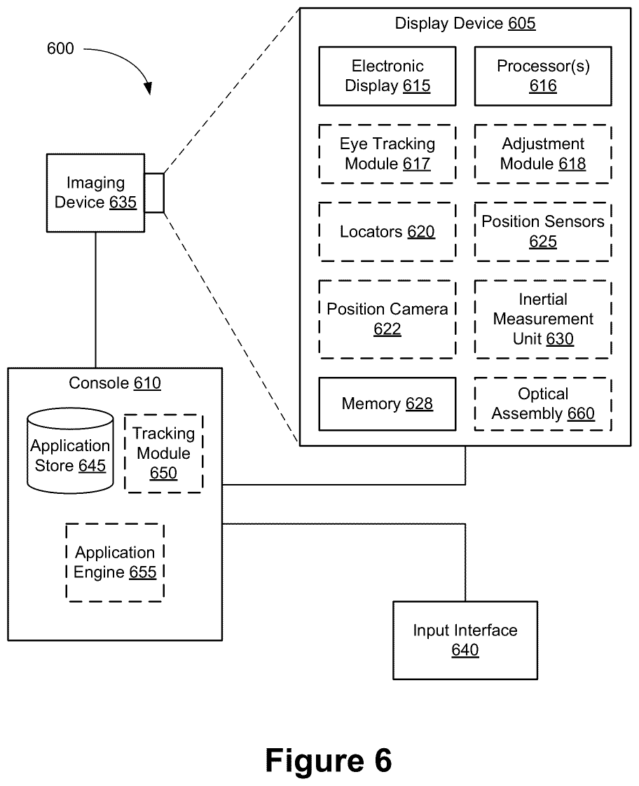

In some embodiments, display device 500 includes one or more components described below with respect to FIG. 6, including one or more components made by any method described herein. In some embodiments, display device 500 includes additional components not shown in FIG. 6.

FIG. 6 is a block diagram of system 600 in accordance with some embodiments. The system 600 shown in FIG. 6 includes display device 605 (which corresponds to display device 500 shown in FIG. 5), imaging device 635, and input interface 640 that are each coupled to console 610. While FIG. 6 shows an example of system 600 including one display device 605, imaging device 635, and input interface 640, in other embodiments, any number of these components may be included in system 600. For example, there may be multiple display devices 605 each having an associated input interface 640 and being monitored by one or more imaging devices 635, with each display device 605, input interface 640, and imaging device 635 communicating with console 610. In alternative configurations, different and/or additional components may be included in system 600. For example, in some embodiments, console 610 is connected via a network (e.g., the Internet) to system 600 or is self-contained as part of display device 605 (e.g., physically located inside display device 605). In some embodiments, display device 605 is used to create mixed reality by adding in a view of the real surroundings. Thus, display device 605 and system 600 described here can deliver virtual reality, mixed reality, and/or augmented reality.

In some embodiments, as shown in FIG. 5, display device 605 is a head-mounted display that presents media to a user. Examples of media presented by display device 605 include one or more images, video, audio, haptics, or some combination thereof. In some embodiments, audio is presented via an external device (e.g., speakers and/or headphones) that receives audio information from display device 605, console 610, or both, and presents audio data based on the audio information. In some embodiments, display device 605 immerses a user in a virtual environment.

In some embodiments, display device 605 also acts as an augmented reality (AR) headset. In these embodiments, display device 605 can augment views of a physical, real-world environment with computer-generated elements (e.g., images, video, sound, haptics, etc.). Moreover, in some embodiments, display device 605 is able to cycle between different types of operation. Thus, display device 605 operate as a virtual reality (VR) device, an AR device, as glasses or some combination thereof (e.g., glasses with no optical correction, glasses optically corrected for the user, sunglasses, or some combination thereof) based on instructions from application engine 655.

Display device 605 includes electronic display 615, one or more processors 616, eye tracking module 617, adjustment module 618, one or more locators 620, one or more position sensors 625, one or more position cameras 622, memory 628, inertial measurement unit (IMU) 630, optical assembly 660, or a subset or superset thereof (e.g., display device 605 with electronic display 615, one or more processors 616, and memory 628, without any other listed components). Some embodiments of display device 605 have different modules than those described here. Similarly, the functions can be distributed among the modules in a different manner than is described here.

One or more processors 616 (e.g., processing units or cores) execute instructions stored in memory 628. Memory 628 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 628, or alternately the non-volatile memory device(s) within memory 628, includes a non-transitory computer readable storage medium. In some embodiments, memory 628 or the computer readable storage medium of memory 628 stores programs, modules and data structures, and/or instructions for displaying one or more images on electronic display 615.

Electronic display 615 displays images to the user in accordance with data received from console 610 and/or processor(s) 616. In various embodiments, electronic display 615 may comprise a single adjustable electronic display element or multiple adjustable electronic displays elements (e.g., a display for each eye of a user).

In some embodiments, the display element includes one or more light emission devices and a corresponding array of emission intensity array. An emission intensity array is an array of electro-optic pixels, opto-electronic pixels, some other array of devices that dynamically adjust the amount of light transmitted by each device, or some combination thereof. These pixels are placed behind one or more lenses. In some embodiments, the emission intensity array is an array of liquid crystal based pixels in an LCD (a Liquid Crystal Display). Examples of the light emission devices include: an organic light emitting diode, an active-matrix organic light-emitting diode, a light emitting diode, some type of device capable of being placed in a flexible display, or some combination thereof. The light emission devices include devices that are capable of generating visible light (e.g., red, green, blue, etc.) used for image generation. The emission intensity array is configured to selectively attenuate individual light emission devices, groups of light emission devices, or some combination thereof. Alternatively, when the light emission devices are configured to selectively attenuate individual emission devices and/or groups of light emission devices, the display element includes an array of such light emission devices without a separate emission intensity array.

The optical assembly 660 includes one or more optical components (e.g., lenses) for directing light from the arrays of light emission devices (optionally through the emission intensity arrays) to locations within each eyebox and ultimately to the back of the user's retina(s). An eyebox is a region that is occupied by an eye of a user located proximate to display device 605 (e.g., a user wearing display device 605) for viewing images from display device 605. In some cases, the eyebox is represented as a 10 mm×10 mm square. In some embodiments, the one or more lenses include one or more coatings, such as anti-reflective coatings. The optical assembly 660 includes one or more optical components made by any method described herein.

In some embodiments, the display element includes an infrared (IR) detector array that detects IR light that is retro-reflected from the retinas of a viewing user, from the surface of the corneas, lenses of the eyes, or some combination thereof. The IR detector array includes an IR sensor or a plurality of IR sensors that each correspond to a different position of a pupil of the viewing user's eye. In alternate embodiments, other eye tracking systems may also be employed.

Eye tracking module 617 determines locations of each pupil of a user's eyes. In some embodiments, eye tracking module 617 instructs electronic display 615 to illuminate the eyebox with IR light (e.g., via IR emission devices in the display element).

A portion of the emitted IR light will pass through the viewing user's pupil and be retro-reflected from the retina toward the IR detector array, which is used for determining the location of the pupil. Alternatively, the reflection off of the surfaces of the eye is also used to determine the location of the pupil. The IR detector array scans for retro-reflection and identifies which IR emission devices are active when retro-reflection is detected. Eye tracking module 617 may use a tracking lookup table and the identified IR emission devices to determine the pupil locations for each eye. The tracking lookup table maps received signals on the IR detector array to locations (corresponding to pupil locations) in each eyebox. In some embodiments, the tracking lookup table is generated via a calibration procedure (e.g., user looks at various known reference points in an image and eye tracking module 617 maps the locations of the user's pupil while looking at the reference points to corresponding signals received on the IR tracking array). As mentioned above, in some embodiments, system 600 may use other eye tracking systems than the embedded IR one described above.

Adjustment module 618 generates an image frame based on the determined locations of the pupils. In some embodiments, this sends a discrete image to the display such that will tile subimages together thus a coherent stitched image will appear on the back of the retina. Adjustment module 618 adjusts an output (i.e. the generated image frame) of electronic display 615 based on the detected locations of the pupils. Adjustment module 618 instructs portions of electronic display 615 to pass image light to the determined locations of the pupils. In some embodiments, adjustment module 618 also instructs the electronic display not to pass image light to positions other than the determined locations of the pupils. Adjustment module 618 may, for example, block and/or stop light emission devices whose image light falls outside of the determined pupil locations, allow other light emission devices to emit image light that falls within the determined pupil locations, translate and/or rotate one or more display elements, dynamically adjust curvature and/or refractive power of one or more active lenses in the lens (e.g., microlens) arrays, or some combination thereof.

Optional locators 620 are objects located in specific positions on display device 605 relative to one another and relative to a specific reference point on display device 605. A locator 620 may be a light emitting diode (LED), a corner cube reflector, a reflective marker, a type of light source that contrasts with an environment in which display device 605 operates, or some combination thereof. In embodiments where locators 620 are active (i.e., an LED or other type of light emitting device), locators 620 may emit light in the visible band (e.g., about 400 nm to 750 nm), in the infrared band (e.g., about 750 nm to 1 mm), in the ultraviolet band (about 100 nm to 400 nm), some other portion of the electromagnetic spectrum, or some combination thereof.

In some embodiments, locators 620 are located beneath an outer surface of display device 605, which is transparent to the wavelengths of light emitted or reflected by locators 620 or is thin enough to not substantially attenuate the wavelengths of light emitted or reflected by locators 620. Additionally, in some embodiments, the outer surface or other portions of display device 605 are opaque in the visible band of wavelengths of light. Thus, locators 620 may emit light in the IR band under an outer surface that is transparent in the IR band but opaque in the visible band.

IMU 630 is an electronic device that generates calibration data based on measurement signals received from one or more position sensors 625. Position sensor 625 generates one or more measurement signals in response to motion of display device 605. Examples of position sensors 625 include: one or more accelerometers, one or more gyroscopes, one or more magnetometers, another suitable type of sensor that detects motion, a type of sensor used for error correction of IMU 630, or some combination thereof. Position sensors 625 may be located external to IMU 630, internal to IMU 630, or some combination thereof.

Based on the one or more measurement signals from one or more position sensors 625, IMU 630 generates first calibration data indicating an estimated position of display device 605 relative to an initial position of display device 605. For example, position sensors 625 include multiple accelerometers to measure translational motion (forward/back, up/down, left/right) and multiple gyroscopes to measure rotational motion (e.g., pitch, yaw, roll). In some embodiments, IMU 630 rapidly samples the measurement signals and calculates the estimated position of display device 605 from the sampled data. For example, IMU 630 integrates the measurement signals received from the accelerometers over time to estimate a velocity vector and integrates the velocity vector over time to determine an estimated position of a reference point on display device 605. Alternatively, IMU 630 provides the sampled measurement signals to console 610, which determines the first calibration data. The reference point is a point that may be used to describe the position of display device 605. While the reference point may generally be defined as a point in space; however, in practice the reference point is defined as a point within display device 605 (e.g., a center of IMU 630).

In some embodiments, IMU 630 receives one or more calibration parameters from console 610. As further discussed below, the one or more calibration parameters are used to maintain tracking of display device 605. Based on a received calibration parameter, IMU 630 may adjust one or more IMU parameters (e.g., sample rate). In some embodiments, certain calibration parameters cause IMU 630 to update an initial position of the reference point so it corresponds to a next calibrated position of the reference point. Updating the initial position of the reference point as the next calibrated position of the reference point helps reduce accumulated error associated with the determined estimated position. The accumulated error, also referred to as drift error, causes the estimated position of the reference point to “drift” away from the actual position of the reference point over time.

Imaging device 635 generates calibration data in accordance with calibration parameters received from console 610. Calibration data includes one or more images showing observed positions of locators 620 that are detectable by imaging device 635. In some embodiments, imaging device 635 includes one or more still cameras, one or more video cameras, any other device capable of capturing images including one or more locators 620, or some combination thereof. Additionally, imaging device 635 may include one or more filters (e.g., used to increase signal to noise ratio). Imaging device 635 is optionally configured to detect light emitted or reflected from locators 620 in a field of view of imaging device 635. In embodiments where locators 620 include passive elements (e.g., a retroreflector), imaging device 635 may include a light source that illuminates some or all of locators 620, which retro-reflect the light towards the light source in imaging device 635. Second calibration data is communicated from imaging device 635 to console 610, and imaging device 635 receives one or more calibration parameters from console 610 to adjust one or more imaging parameters (e.g., focal length, focus, frame rate, ISO, sensor temperature, shutter speed, aperture, etc.).

Input interface 640 is a device that allows a user to send action requests to console 610. An action request is a request to perform a particular action. For example, an action request may be to start or end an application or to perform a particular action within the application. Input interface 640 may include one or more input devices. Example input devices include: a keyboard, a mouse, a game controller, data from brain signals, data from other parts of the human body, or any other suitable device for receiving action requests and communicating the received action requests to console 610. An action request received by input interface 640 is communicated to console 610, which performs an action corresponding to the action request. In some embodiments, input interface 640 may provide haptic feedback to the user in accordance with instructions received from console 610. For example, haptic feedback is provided when an action request is received, or console 610 communicates instructions to input interface 640 causing input interface 640 to generate haptic feedback when console 610 performs an action.

Console 610 provides media to display device 605 for presentation to the user in accordance with information received from one or more of: imaging device 635, display device 605, and input interface 640. In the example shown in FIG. 6, console 610 includes application store 645, tracking module 650, and application engine 655. Some embodiments of console 610 have different modules than those described in conjunction with FIG. 6. Similarly, the functions further described below may be distributed among components of console 610 in a different manner than is described here.

When application store 645 is included in console 610, application store 645 stores one or more applications for execution by console 610. An application is a group of instructions, that when executed by a processor, is used for generating content for presentation to the user. Content generated by the processor based on an application may be in response to inputs received from the user via movement of display device 605 or input interface 640. Examples of applications include: gaming applications, conferencing applications, video playback application, or other suitable applications.

When tracking module 650 is included in console 610, tracking module 650 calibrates system 600 using one or more calibration parameters and may adjust one or more calibration parameters to reduce error in determination of the position of display device 605. For example, tracking module 650 adjusts the focus of imaging device 635 to obtain a more accurate position for observed locators on display device 605. Moreover, calibration performed by tracking module 650 also accounts for information received from IMU 630. Additionally, if tracking of display device 605 is lost (e.g., imaging device 635 loses line of sight of at least a threshold number of locators 620), tracking module 650 re-calibrates some or all of system 600.

In some embodiments, tracking module 650 tracks movements of display device 605 using second calibration data from imaging device 635. For example, tracking module 650 determines positions of a reference point of display device 605 using observed locators from the second calibration data and a model of display device 605. In some embodiments, tracking module 650 also determines positions of a reference point of display device 605 using position information from the first calibration data. Additionally, in some embodiments, tracking module 650 may use portions of the first calibration data, the second calibration data, or some combination thereof, to predict a future location of display device 605. Tracking module 650 provides the estimated or predicted future position of display device 605 to application engine 655.

Application engine 655 executes applications within system 600 and receives position information, acceleration information, velocity information, predicted future positions, or some combination thereof of display device 605 from tracking module 650. Based on the received information, application engine 655 determines content to provide to display device 605 for presentation to the user. For example, if the received information indicates that the user has looked to the left, application engine 655 generates content for display device 605 that mirrors the user's movement in a virtual environment. Additionally, application engine 655 performs an action within an application executing on console 610 in response to an action request received from input interface 640 and provides feedback to the user that the action was performed. The provided feedback may be visual or audible feedback via display device 605 or haptic feedback via input interface 640.

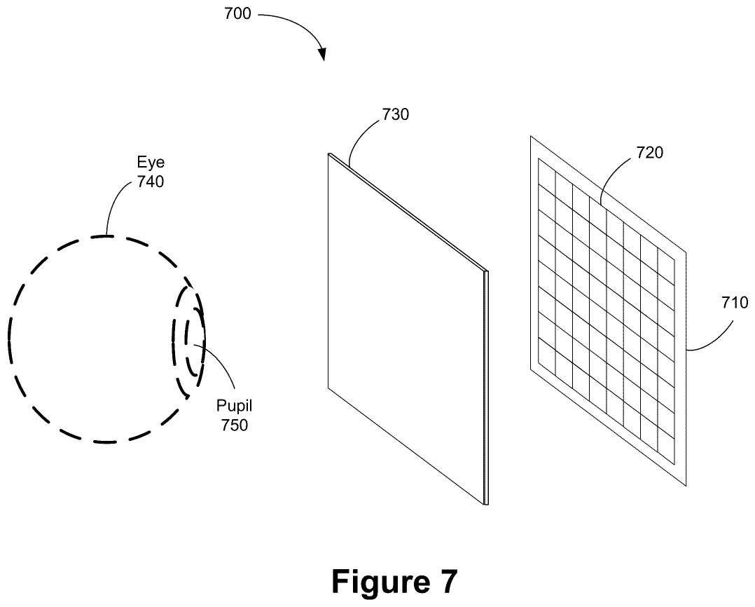

FIG. 7 is an isometric view of display device 700 in accordance with some embodiments. In some other embodiments, display device 700 is part of some other electronic display (e.g., digital microscope, etc.). In some embodiments, display device 700 includes light emission device array 710 and one or more lenses 730. In some embodiments, the one or more lenses 730 include a lens made by any method described herein. In some embodiments, display device 700 also includes an emission intensity array and an IR detector array.

Light emission device array 710 emits image light and optional IR light toward the viewing user. Light emission device array 710 may be, e.g., an array of LEDs, an array of microLEDs, an array of OLEDs, or some combination thereof. Light emission device array 710 includes light emission devices 720 that emit light in the visible light (and optionally includes devices that emit light in the IR). In some embodiments, a microLED includes an LED with an emission area characterized by a representative dimension (e.g., a diameter, a width, a height, etc.) of 100 μm or less (e.g., 50 μm, 20 μm, etc.). In some embodiments, a microLED has an emission area having a shape of a circle or a rectangle.

The emission intensity array is configured to selectively attenuate light emitted from light emission array 710. In some embodiments, the emission intensity array is composed of a plurality of liquid crystal cells or pixels, groups of light emission devices, or some combination thereof. Each of the liquid crystal cells is, or in some embodiments, groups of liquid crystal cells are, addressable to have specific levels of attenuation. For example, at a given time, some of the liquid crystal cells may be set to no attenuation, while other liquid crystal cells may be set to maximum attenuation. In this manner the emission intensity array is able to control what portion of the image light emitted from light emission device array 710 is passed to the one or more lenses 730. In some embodiments, display device 700 uses the emission intensity array to facilitate providing image light to a location of pupil 750 of eye 740 of a user, and minimize the amount of image light provided to other areas in the eyebox.

One or more lenses 730 receive the modified image light (e.g., attenuated light) from the emission intensity array (or directly from light emission device array 710), and shifted by one or more beam shifters 760, and direct the shifted image light to a location of pupil 750.

An optional IR detector array detects IR light that has been retro-reflected from the retina of eye 740, a cornea of eye 740, a crystalline lens of eye 740, or some combination thereof. The IR detector array includes either a single IR sensor or a plurality of IR sensitive detectors (e.g., photodiodes). In some embodiments, the IR detector array is separate from light emission device array 710. In some embodiments, the IR detector array is integrated into light emission device array 710.

In some embodiments, light emission device array 710 and the emission intensity array make up a display element. Alternatively, the display element includes light emission device array 710 (e.g., when light emission device array 710 includes individually adjustable pixels) without the emission intensity array. In some embodiments, the display element additionally includes the IR array. In some embodiments, in response to a determined location of pupil 750, the display element adjusts the emitted image light such that the light output by the display element is refracted by one or more lenses 730 toward the determined location of pupil 750, and not toward other locations in the eyebox.

In light of these principles, we turn to certain embodiments.

In accordance with some embodiments, a mold assembly (e.g., mold assembly 100) includes a first mold (e.g., mold 102), a second mold (e.g., mold 104), and a lock (e.g., lock 106) mounted on one of the first mold or the second mold and releasably coupled with the other of the first mold or the second mold for maintaining a position of the other of the first mold or the second mold relative to the one of the first mold or the second mold while the lock is in a closed position.

In some embodiments, the lock is mounted on the first mold and releasably coupled with the second mold for maintaining the position of the second mold relative to the first mold while the lock is in the closed position.

In some embodiments, the lock is mounted on the second mold and releasably coupled with the first mold for maintaining the position of the first mold relative to the second mold while the lock is in the closed position.

In some embodiments, the lock is rotatably mounted on the one of the first mold or the second mold.

In some embodiments, the second mold is rotatably coupled to the first mold. In some embodiments, the mold assembly includes a hinge for rotatably coupling the second mold to the first mold.

In some embodiments, the mold assembly includes a handle (e.g., handle 110) coupled to the second mold for at least partially separating the second mold from the first mold.

In some embodiments, the mold assembly includes a position indicator (e.g., marker 112).

In accordance with some embodiments, an apparatus (e.g., the apparatus shown in FIG. 3C or 3D) for molding includes a first platen (e.g., platen 204); a second platen (e.g., platen 202); and one or more actuators coupled with at least one of the first platen or the second platen for: changing a distance between the first platen and the second platen; and changing a position of a mold assembly on the second platen relative to the first platen. For example, the apparatus shown in FIG. 3C includes an actuator 314 for moving the platen 204 to change the distance between the platen 204 and the platen 202, and an actuator 312 for rotating the platen 202 for changing a position of a mold assembly on the platen 202.

In some embodiments, the one or more actuators include a first actuator (e.g., actuator 314) coupled with the first platen for moving the first platen relative to the second platen. In some embodiments, the first actuator is configured to change the distance between the first platen and the second platen.

In some embodiments, the one or more actuators include a second actuator (e.g., actuator 312) coupled with the second platen for moving the second platen relative to the first platen. In some embodiments, the second actuator is configured to rotate the second platen relative to the first platen.

In some embodiments, the apparatus includes an actuator positioned to disengage a lock of the mold assembly (e.g., actuator 334).

In some embodiments, the apparatus includes an actuator (e.g., actuator 332) positioned to open a second mold of the mold assembly.

In some embodiments, the mold assembly on the second platen is any mold assembly described herein (e.g., the mold assembly 100).

In some embodiments, a second mold assembly is located on the second platen (e.g., as shown in FIG. 3A, two or more mold assemblies may be placed on the platen 302).

Embodiments described herein may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

1. A mold assembly, comprising:
a first mold;
a second mold; and
a lock mounted on one of the first mold or the second mold and releasably coupled with the other of the first mold or the second mold for maintaining a position of the other of the first mold or the second mold relative to the one of the first mold or the second mold while the lock is in a closed position.

2. The mold assembly of claim 1, wherein:
the lock is mounted on the first mold and releasably coupled with the second mold for maintaining the position of the second mold relative to the first mold while the lock is in the closed position.

3. The mold assembly of claim 1, wherein:
the lock is mounted on the second mold and releasably coupled with the first mold for maintaining the position of the first mold relative to the second mold while the lock is in the closed position.

4. The mold assembly of claim 1, wherein:
the lock is rotatably mounted on the one of the first mold or the second mold.

5. The mold assembly of claim 1, wherein:
the second mold is rotatably coupled to the first mold.

6. The mold assembly of claim 1, further comprising:
a hinge for rotatably coupling the second mold to the first mold.

7. The mold assembly of claim 1, further comprising:
a handle coupled to the second mold for at least partially separating the second mold from the first mold.

8. The mold assembly of claim 1, further comprising:
a position indicator.

9. An apparatus for molding, comprising:
a first platen;
a second platen; and
one or more actuators coupled with at least one of the first platen or the second platen for:
changing a distance between the first platen and the second platen; and
changing a position of a mold assembly on the second platen relative to the first platen.

10. The apparatus of claim 9, wherein:
the one or more actuators include a first actuator coupled with the first platen for moving the first platen relative to the second platen.

11. The apparatus of claim 10, wherein:
the first actuator is configured to change the distance between the first platen and the second platen.

12. The apparatus of claim 9, wherein:
the one or more actuators include a second actuator coupled with the second platen for moving the second platen relative to the first platen.

13. The apparatus of claim 12, wherein:
the second actuator is configured to rotate the second platen relative to the first platen.

14. The apparatus of claim 9, further comprising:
an actuator positioned to disengage a lock of the mold assembly.

15. The apparatus of claim 9, further comprising:
an actuator positioned to open a second mold of the mold assembly.

16. The apparatus of claim 9, wherein:
the mold assembly on the second platen is the mold assembly of claim 1.

17. The apparatus of claim 9, wherein:
a second mold assembly is located on the second platen.

18. A method, comprising:
maintaining the first platen of the apparatus of claim 9 in contact with a second mold of the mold assembly located at a first position while molten material is in the mold assembly;
releasing the first platen from the second mold of the mold assembly; and
subsequent to releasing the first platen from the second mold of the mold assembly, moving the mold assembly from the first position to a second position distinct from the first position.

19. The method of claim 18, including:
moving a second mold assembly to the first position concurrently with moving the mold assembly from the first position to the second position.

20. The method of claim 19, further comprising:
maintaining the first platen in contact with a second mold of the second mold assembly located at the first position; and
cooling the mold assembly at least while the first platen is in contact with the second mold of the second mold assembly.
